(19) United States
(12) Patent Application Publication
(10) Pub. No.: US 2020/0370627 A1
(43) Pub. Date: Nov. 26, 2020

(54) BELT TENSIONER WITH SLIDING PULLEY

(71) Applicant: BorgWarner Inc., Auburn Hills, MI (US)

(72) Inventors: Lorenzo CAPROTTI, Vimercate (IT); Daniel BROWN, Freeville, NY (US); Shawn BLACKMUR, Brooktondale, NY (US)

(21) Appl. No.: 16/966,272

(22) PCT Filed: Feb. 19, 2019
(86) PCT No.: PCT/US2019/018491

§ 371 Date: Jul. 30, 2020

Related U.S. Application Data
(60) Provisional application No. 62/632,004, filed on Feb. 19, 2018.

(51) Int. Cl. F16H 7/12

(52) U.S. Cl. CPC F16H 7/1263; F16H 2007/0808

(57) ABSTRACT

A tensioner with a bracket, a tensioner body coupled to the bracket for rotation about a first axis, a first and second wheels that are coupled to the tensioner body for rotation about second and third axes, respectively, that are parallel the first axis, and a spring that biases the second wheel along a line of action relative to the tensioner body. The second wheel is coupled to the tensioner body for movement between first and second positions along the line of action.

### FIELD

The present disclosure relates to a belt tensioner with a sliding pulley.

### BACKGROUND

This section provides background information related to the present disclosure which is not necessarily prior art.

Front engine accessory drives (FEAD's) commonly employ a belt that is driven by an engine crankshaft to provide rotary power to various engine accessories, including an alternator. A belt tensioner is employed in on the slack side of the belt in the FEAD to ensure that the belt is tensioned in a desired manner that prevents slippage between the belt and the pulleys about which the belt is wrapped.

In a FEAD in having a starter/alternator (i.e., an alternator that can be operated as a starter motor to drive the belt and cause corresponding rotation of the engine crankshaft to start the engine), the operation of the starter/alternator can cause a swapping of the slack and tight sides of the belt. Consequently, a conventional tensioner would not effectively tension the belt of the FEAD when the starter/alternator is employed to start or boost the engine. Various solutions employing a pair of spring-loaded pulleys have been suggested. Generally, these solutions employ pivoting arms onto which the spring-loaded pulleys are mounted and may include complex spring configurations.

### SUMMARY

This section provides a general summary of the disclosure, and is not a comprehensive disclosure of its full scope or all of its features.

In one form, the teachings of the present disclosure provide a tensioner with a bracket, a tensioner body coupled to the bracket for rotation about a first axis, a first wheel that is coupled to the tensioner body for rotation about a second axis that is parallel to the first axis, a second wheel that is rotatable about a third axis that is parallel to the first axis, and a spring that biases the second wheel toward the first wheel. The second wheel is coupled to the tensioner body for movement between a first position and a second position.

In some forms, the tensioner includes a washer that is received between the bracket and the tensioner body.

In some forms, the second wheel is mounted to an axle and the tensioner body includes a guide rail that constrains movement of the axle along the line of action. In one optional alternative, the spring includes a hook that is disposed about the axle. In another optional alternative, a friction material is disposed between the axle and the tensioner body.

In some forms, the first wheel is mounted to an axle that is fixedly coupled to the tensioner body.

In some forms, the tensioner body defines a spring groove into which the spring is received. Optionally, the spring groove extends along the line of action.

In some forms, the spring comprises a torsion spring. Optionally, the torsion spring has a plurality of helical coils, which are disposed about a portion of the bracket, and a tang that extends through the tensioner body hub. In one optional alternative, the tang engages a lever, which is mounted to a pivot on the tensioner hub, and the second axle is fixedly coupled to the lever. In another optional alternative, the tang engages a surface of a follower that is disposed concentrically about the second axle. Optionally, the tang is disposed between the first and second axles.

In some forms, the second wheel is biased toward the first wheel.

In some forms, the second axis lies along the line of action.

In another form, the teachings of the present disclosure provide a tensioner having a bracket with a bracket hub, a tensioner body, first and second axles, first and second wheels and a spring. The tensioner body has a tensioner body hub, and first and second mounts that are fixedly coupled to the tensioner body hub. The tensioner body hub is rotatably coupled to the bracket hub. The first axle is fixedly coupled to the first mount, while the second axle is slidably coupled to the second mount. The first wheel is rotatably disposed on the first axle and the second wheel is rotatably disposed on the second axle. The spring is coupled to the tensioner body and biases the second wheel in a predetermined direction along a line of action.

In some forms, the tensioner also includes a friction control element that is received between the bracket and the tensioner body. Optionally, one of the bracket hub and the tensioner body hub defines an aperture into which the other one of the bracket hub and the tensioner body hub is received, and the friction control element is disposed about the other one of the bracket hub and the tensioner body. Also optionally, the bracket hub defines a first annular surface, the tensioner body hub defines a second annular surface, and the friction control element is disposed axially between the first and second annular surfaces.

In some forms, the second axle includes a plate that is slidably but non-rotatably coupled to the second mount. Optionally, the second mount defines one or more guide rails that guide the plate as the second axle is moved relative to the first axle between first and second positions. Also optionally, a friction material is disposed between the plate and the second mount.

In some forms, the second axle is movable relative to the first axle between a first position, in which the first and second axles are spaced apart by a first distance, and a second position in which the first and second axles are spaced apart by a second distance that is smaller than the first distance, and an axis of the first axle is disposed along the line of action.

In some forms, the spring has a first hooked end that is disposed about one of the first and second axles. Optionally, the spring has a second hooked end that is disposed about the other one of the first and second axles.

In some forms, the spring comprises a torsion spring. Optionally, the torsion spring has a plurality of helical coils, which are disposed about a portion of the bracket, and a tang that extends through the tensioner body hub. In one alternative, the tang engages a lever that is pivotally mounted to the tensioner hub, and wherein the second axle is fixedly coupled to the lever. In a second alternative, the tang engages a surface of a follower that is disposed concentrically about the second axle. In this second alternative, the tang is optionally disposed between the first and second axles.

In some forms, the second wheel is biased toward the first wheel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary tensioner constructed in accordance with the teachings of the present disclosure;

FIG. 2 is a front elevation view of the tensioner of FIG. 1;

FIG. 3 is an exploded perspective view of the tensioner of FIG. 1;

FIG. 4 is a section view taken along the line 4-4 of FIG. 2;

FIG. 5 is a section view taken along the line 5-5 of FIG. 2

FIG. 6 is a front elevation view of a portion of the tensioner of FIG. 1 illustrating the movement of an axle along a straight line that intersects an axis of another axle;

FIGS. 7 through 9 are illustrations that are similar to that of FIG. 6 but which depict movement of the axle along differently shaped lines of action or paths of travel;

FIG. 10 is a perspective view of a second exemplary tensioner constructed in accordance with the teachings of the present disclosure;

FIG. 11 is a bottom view of the tensioner of FIG. 10;

FIG. 12 is a section view taken along the line 12-12 of FIG. 11; and

FIG. 13 is a section view taken along the line 13-13 of FIG. 11.

FIG. 14 is a front perspective view of a third exemplary tensioner constructed in accordance with the teachings of the present disclosure;

FIG. 15 is a rear perspective view of the tensioner of FIG. 14;

FIG. 16 is an exploded perspective view of the tensioner of FIG. 14;

FIG. 17 is a front elevation view of a fourth exemplary tensioner constructed in accordance with the teachings of the present disclosure, the tensioner being shown in operative association with an internal combustion engine as part of a front engine accessory drive;

FIG. 18 is a front perspective view of the tensioner of FIG. 17;

FIG. 19 is an exploded perspective view of the tensioner of FIG. 17;

FIGS. 20 and 21 are front elevation views of exemplary tensioners that are similar to the tensioner of FIG. 17 except for the manner in which the movable pulley is biased relative to the non-movable pulley.

Corresponding reference numerals indicate corresponding parts throughout the several views of the drawings.

### DETAILED DESCRIPTION

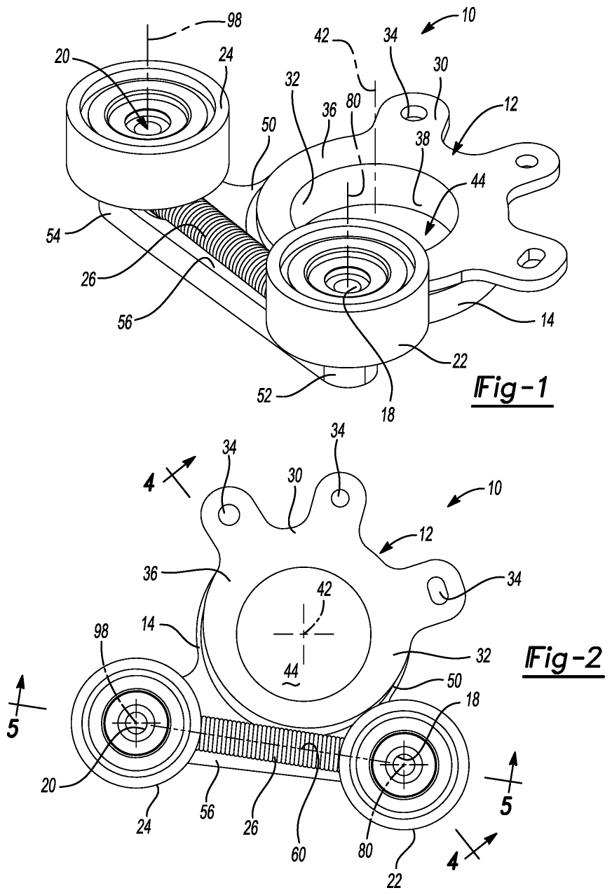

With reference to FIGS. 1 through 3, an exemplary tensioner constructed in accordance with the teachings of the present disclosure is generally indicated by reference numeral 10. The tensioner 10 can include a bracket 12, a tensioner body 14, a friction control element 16, a first axle 18, a second axle 20, a first wheel 22, a second wheel 24 and a spring 26.

The bracket 12 can include a mounting flange 30 and a bracket hub 32. The mounting flange 30 is configured to permit the bracket 12 to be fixedly coupled to a desired structure, such as an internal combustion engine (not shown). In the example provided, the mounting flange 30 defines a plurality of mounting apertures 34 that are configured to receive threaded fasteners (not shown) there through that are threadably coupled to the internal combustion engine. The bracket hub 32 can include a hub flange 36, which can be fixedly coupled to the mounting flange 30, and a hub member 38 that can have a circumferentially extending hub member surface 40 that can extend along a first axis 42. In the example provided, the hub member 38 is an annular structure having a bracket aperture 44 formed there through to reduce the mass and cost of the bracket 12. It will be appreciated, however, that the hub member 38 could be formed differently.

The tensioner body 14 can have a tensioner body hub 50, first and second mounts 52 and 54, which are fixedly coupled to the tensioner body hub 50, and a spring mount 56 that can be disposed between the first and second mounts 52 and 54. The tensioner body hub 50 can be fixedly but rotatably coupled to the bracket hub 32 such that the tensioner body hub 50 can rotate relative to the bracket hub 32 about the first axis 42. In the example provided, the tensioner body hub 50 defines an aperture 58 into which the hub member 38 can be received. It will be appreciated, however, that the hub member 38 could be formed on the tensioner body 14 and the aperture 58 could be formed in the bracket 12. The first and second mounts 52 and 54 can be spaced apart from one another along a straight line of action 60 that is offset from and perpendicular to the first axis 42.

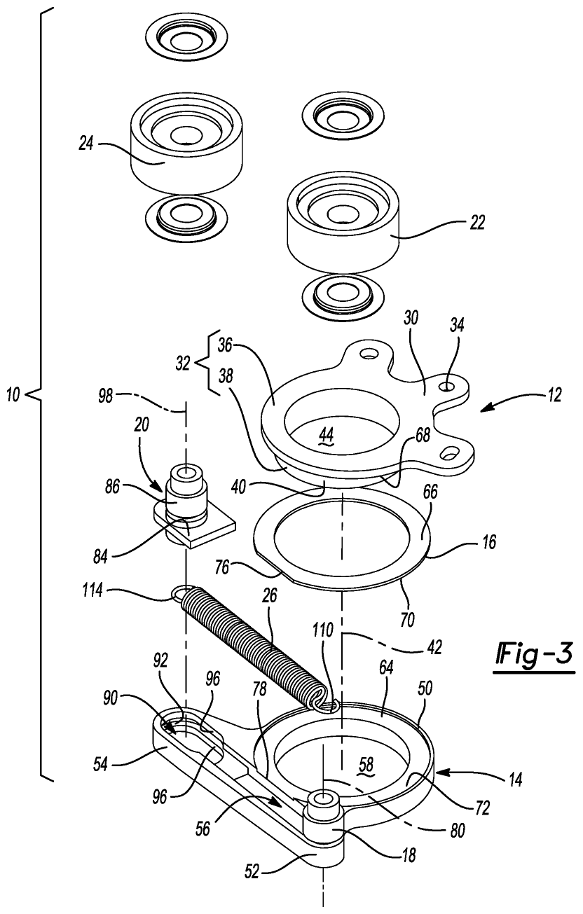

With specific reference to FIGS. 3 and 4, the friction control element 16 can be received between the bracket hub 32 and the tensioner body hub 50 and can have a desired set of tribological properties, such as static and dynamic coefficients of friction. The friction control element 16 could comprise one or more coatings (not shown) of one or more materials formed onto one or more of the surfaces of the bracket hub 32 and the tensioner body hub 50 that contact one another. In the particular example provided, the friction control element 16 is a washer-like (i.e., annular) structure that is received over the hub member 38. The friction control element 16 can be formed of a suitable material, such as a glass-filled polyamide. The friction control element 16 can be received into a counterbore 64 that is formed concentrically with the aperture 58 and can have a first annular surface 66, which can engage or contact an annular surface 68 on the hub flange 36, and a second annular surface 70 that can engage or contact an annular surface 72 formed into the tensioner body hub 50 about the aperture 58. Accordingly, the friction control element 16 can be disposed axially between the annular surface 68 on the hub flange 36 and the annular surface 72 on the tensioner body hub 50. In the example provided, the friction control element 16 has a flat edge 76 formed thereon that engages a corresponding flat edge 78 in the counterbore 58. Engagement of the flat edge 76 with the corresponding flat edge 78 inhibits relative rotation between the friction control element 16 and the tensioner body 14. As such, only the first annular surface 66 on the friction control element 16 need be provided with the desired tribological properties in the example that is illustrated. The friction control element 16 can include an extending surface (not shown) that engages the hub member surface 40 and a corresponding receiving surface on the tensioner body 14. The tensioner body hub 50 may include or interface with an o-ring or other seal or shield that protects the friction element 16 from contaminants.

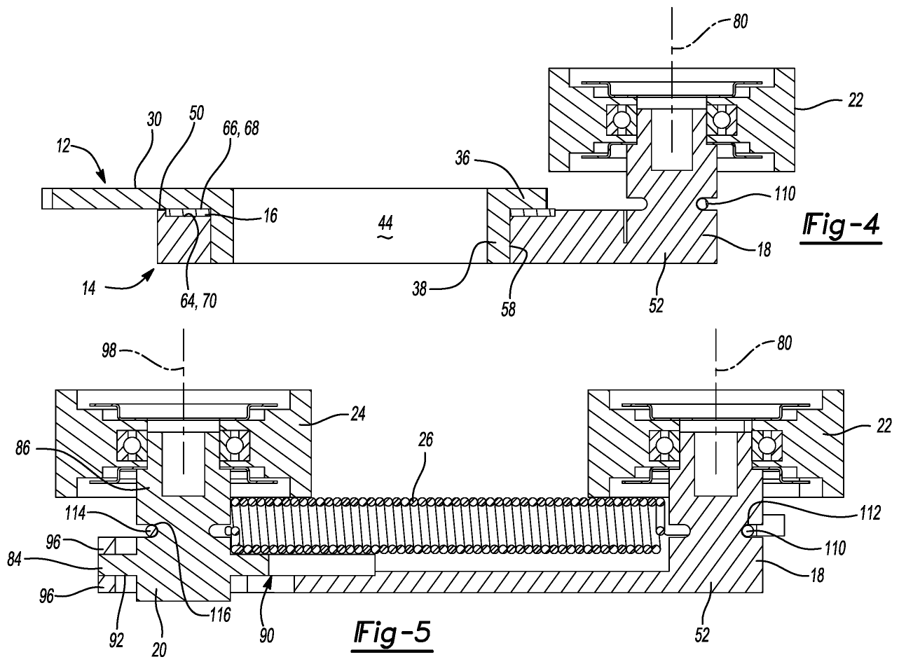

In FIGS. 3 and 5, the first axle 18 can be a shaft-like structure that can be fixedly coupled to the first mount 52 in any desired manner, such as via an interference fit, overmolding (i.e., cohesive bonding of the material that forms the tensioner body 14 to the first axle 18), or one or more fasteners (not shown). Alternatively, the first axle 18 can be unitarily and integrally formed with the tensioner body 14 as is shown in the particular example provided. The first axle 18 can define a second axis 80 that can be parallel to the first axis 42.

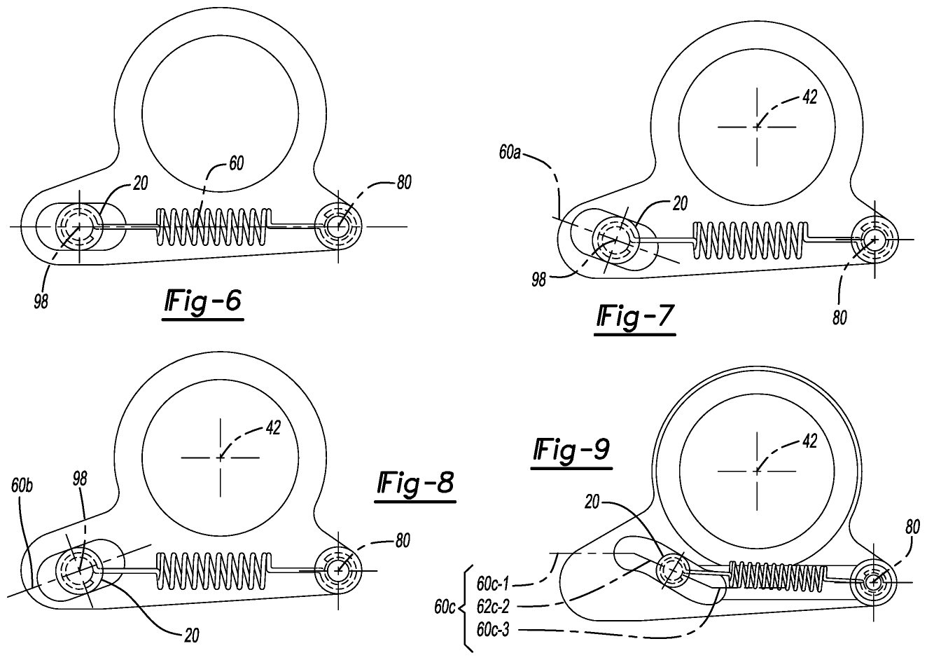

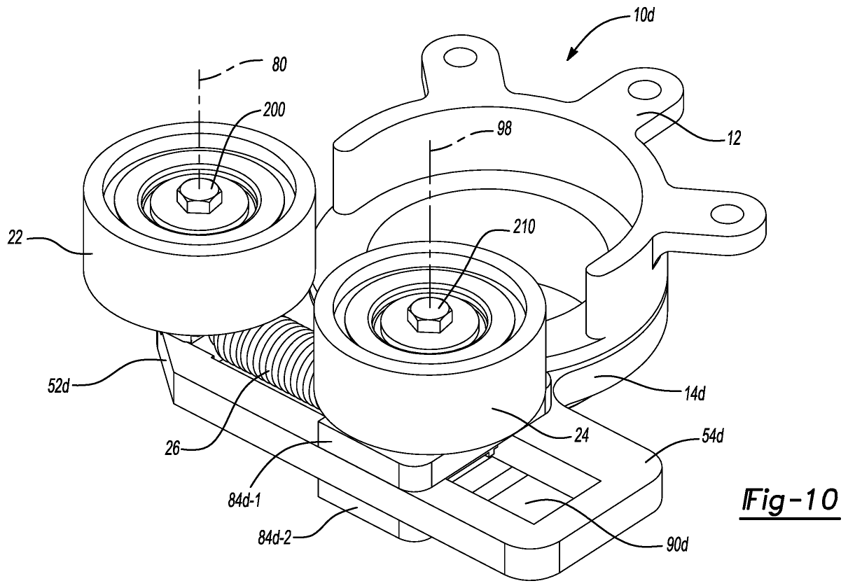

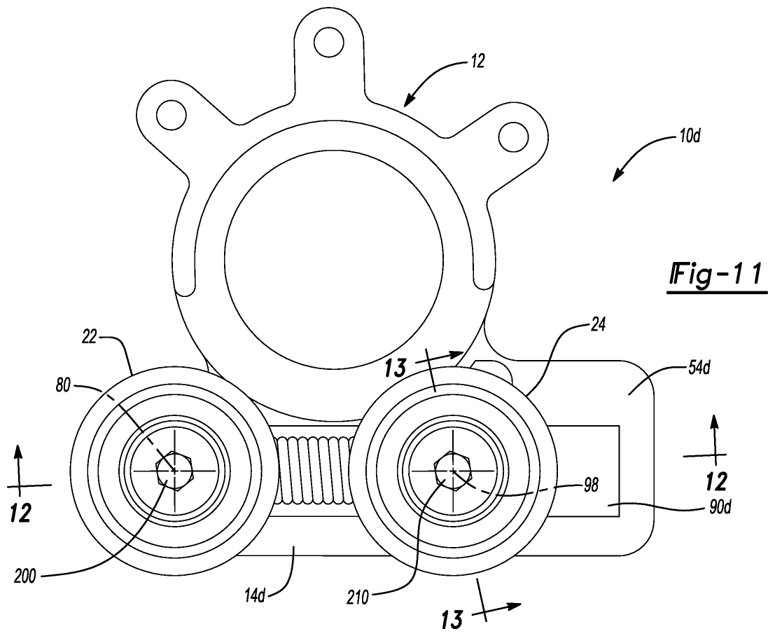

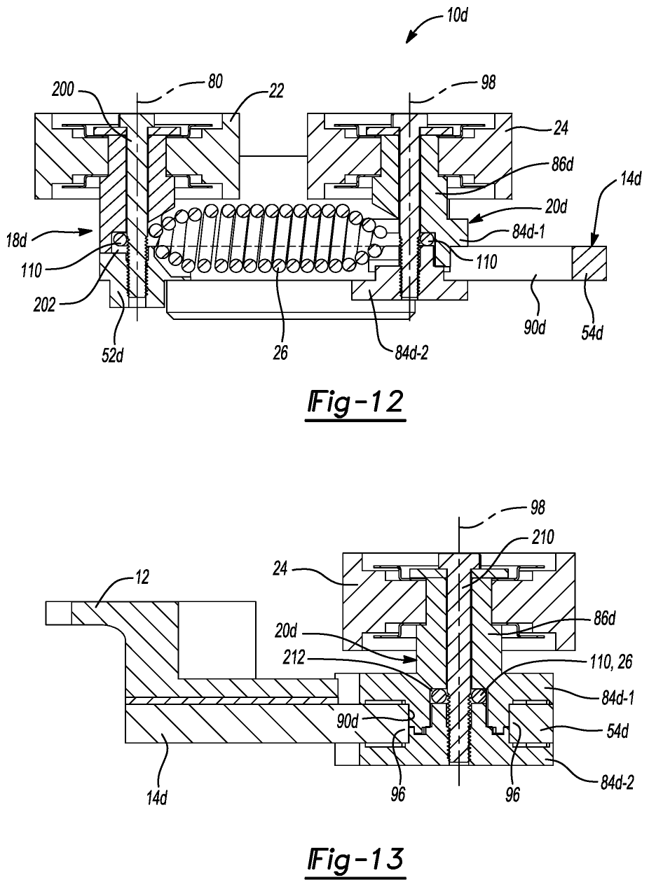

The second axle 20 can include plate 84 and a shaft structure 86. The plate 84 is configured to be slidably coupled to the second mount 54. In the example provided, the second mount 54 forms a plate slot 90 and a plate groove 92 that is formed about the perimeter of the plate slot 90 and completely through an end of the second mount 54. The plate groove 92 forms a pair of guide rails 96 between which the plate 84 is received. The plate 84 can be received through the end of the second mount 54 into the plate slot 90. The guide rails 96 can cooperate with the plate 84 to retain the plate 84 in the second mount 54 and to permit movement of the plate 84 in a predetermined manner (e.g., a manner that is non-rotatable but slidable along a portion of the line of action 60 shown in FIG. 1) relative to the second mount 54. The shaft structure 86 can be fixedly coupled to the plate 84 and can extend about a third axis 98 that can be parallel to the first axis 42. Optionally an end of the shaft structure 84 can be received into a hole (not shown) in the plate 84. If desired, the end of the shaft structure 84 can have a non-circular shape (e.g., square) and the hole in the plate 84 can be matingly shaped so that receipt of the end of the shaft structure 84 into the hole can aid in resisting relative rotation between the shaft structure 86 and the plate 94. The second axle 20 can be translated or slid relative to the second mount 54 in a prescribed manner between a first position, in which the first axle 18 is spaced apart from the second axle 20 by a first distance, and a second position in which the first axle 18 is spaced apart from the second axle 20 by a second distance that is smaller than the first distance. In the particular example provided, movement of the second axle 20 between the first and second positions causes the third axis 98 to move along the line of action 60 (i.e., directly toward or away from the second axis 80). Accordingly, the prescribed manner of movement (i.e., the line of action) in the example provided is a straight line as is depicted in FIG. 6. It will be appreciated, however, that the prescribed manner (i.e., the line of action) could correspond to line that is: a) straight but which does not extend directly toward the second axis 80; b) curved between its opposite ends, or c) is formed with two or more distinct segments that can be differently shaped or mirror images of one another. The examples of FIGS. 7 and 8 depict a prescribed manner (i.e., line of action) in which the line is straight but does not extend directly toward the second axis 80. In FIG. 7, the line of action 60a is sloped such that the line of action 60a is further from the first axis 42 as the second axle 20 is moved closer to the second axis 80. In FIG. 8, the line of action 60b is sloped such that the line 60b is closer to the first axis 42 as the second axle 20 is moved closer to the second axis 80. The example of FIG. 9 depicts movement of the second axle 20 along a line of action or path of travel 60c that has first, second and third segments 60c-1, 60c-2 and 60c-3, respectively. In this example:
a) the third segment 60c-3 extends along a straight line that intersects the second axis 80;
b) the first segment 60c-1 is a straight segment that is parallel to the third segment 60c-3 but is offset from the third segment 60c-3 in a direction that positions the first segment 60c-1 along a line that lies closer to the first axis 42 than the line that extends between the third portion 60c-3 and the second axis 80; and
c) the second segment 60c-2 is a straight section that intersects and connects the first and third segments 60c-1 and 60c-3 in a sloped manner in which the second segment 60c-2 is disposed further from the first axis 40 with decreasing distance to the third segment 60c-3.

It will be appreciated that bearings of one form or another could be employed to reduce friction between the second axle 20 and the second mount 54. Alternatively, the plate 84 could be integrally formed with or coupled to the end of a shaft or rod that is part of a cylinder assembly that is mounted to the tensioner body 14. A shield or seal could be provided to protect the interface between the second axle 20 and the second mount 54. Examples of this protection include a metal or plastic shroud, wipers that clean the guide rails 96, or a bellows covering that flexes as the second axle 20 moves along the line of action 60.

If desired, a friction material can be disposed between the plate 84 and the second mount 54. The friction material could comprise a coating that can be formed or disposed on an outer or exterior surface of the plate 84 and which can engage the guide rails 96 on the second mount 54 as the second axle 20 is moved between the first and second positions.

The first wheel 22 can be coupled to the first axle 18 and can be rotatable about the second axis 80, while the second wheel 24 can be coupled to the second axle 24 and rotatable about the third axis 98. As used herein, the term “wheel” is used to encompass not only pulleys and rollers, but also sprockets and bearings. In the example provided, a conventional bearing is disposed between the first wheel 22 and the second axle 24.

The spring 26 can be configured to bias the second wheel 24 toward the first wheel 22. In the example provided, the spring 26 is an extension spring having a first hooked end 110, which is received in a first spring groove 112 formed about the first axle 18, and a second hooked end 114 that can be received into a second spring groove 116 that is formed about the shaft structure 86 of the second axle 20. The spring 26 can be received into the spring mount 56 formed in the tensioner body 14. It will be appreciated, however, that any type of spring (e.g., compression spring, leaf spring, etc.) could be employed and moreover, that the spring 26 can be disposed in any manner to exert force to bias the second wheel 24 toward the first wheel 22. In this regard, the spring 26 could be engaged directly to the tensioner body 14 in a desired location such that the spring 26 reacts against the tensioner body 14 and the structure that supports the second wheel 24 (i.e., the second axle 20 in the example provided). Direct engagement of the spring 26 to the tensioner body 14 permits the use of a coil compression spring for the spring 26 that can be housed in the second mount 54. While the spring 26 has been depicted as extending along a straight line, it will be appreciated that the spring 26 could be shaped somewhat differently. For example, the spring 26 could extend in an arcuate manner or generally horse shoe-shape (e.g., between the first axle 18 and the shaft structure 86) if desired so that a relatively longer (and stronger) spring could be packaged into the tensioner 10.

If desired, the spring 26 can be housed in a cylinder or hollow tube (not shown) of a cylinder assembly (not shown). The cylinder assembly can have a first cap (not shown), a second cap (not shown) and a rod (not shown). The first cap can be fixedly coupled to a first end of the cylinder and can be coupled to one of the first and second axles 18 and 24. The second cap can be coupled to a second, opposite end of the cylinder. The rod can be slidably received in the cylinder and can extend through the second cap. The spring 26 can be received in the cylinder and can have a first end, which can be coupled to the first cap, and a second end that can be coupled to an end of the rod that is disposed in the cylinder. The opposite end of the rod can be coupled to the other one of the first and second axles 18 and 24. Seals can be provided to keep contaminants out of the cylinder assembly.

With reference to FIGS. 10 through 13, another tensioner constructed in accordance with the teachings of the present disclosure is generally indicated by reference numeral 10d. Except as described herein, the tensioner 10d can be generally similar to the tensioner 10 (FIG. 1).

The first axle 18d can be formed as a separate component and can be assembled to the tensioner body 14d with a threaded fastener 200 that is received through a bore formed in the first axle 18d and threaded into a threaded aperture formed in the first mount 52d. The hook 110 on the spring 26 can be received in a cavity 202 formed in the first axle 18d and can be received about the threaded fastener 200.

The second axle 20d can include a first plate 84d-1, a second plate 84d-2 and a shaft structure 86d that can be fixedly coupled to (e.g., unitarily and integrally formed with) the first plate 84d-1. The first and second plates 84d-1 and 84d-2 can matingly engage one another, and a threaded fastener 210 can be employed to secure the first and second plates 84d-1 and 84d-2 to one another. In the example provided, the threaded fastener 210 is received through a hole formed through the shaft structure 86d and the first plate 84d-1 and is threadably engaged to a threaded aperture formed in the second plate 84d-2. The hook 110 on the spring 26 can be received in a cavity 212 formed in the shaft structure 86d and can be received about the threaded fastener 210. The first and second plates 84d-1 and 84d-2 are sized and shaped to engage the guide rails 96 that are formed in the second mount 54d. It will be appreciated that the “sandwich” configuration of the first and second plates 84d-1 and 84d-2 not only permits the second axle 20d to be guided along the plate slot 90d in the second mount 54d, but also helps to prevent tipping of the third axis 98 relative to the tensioner body 14d.

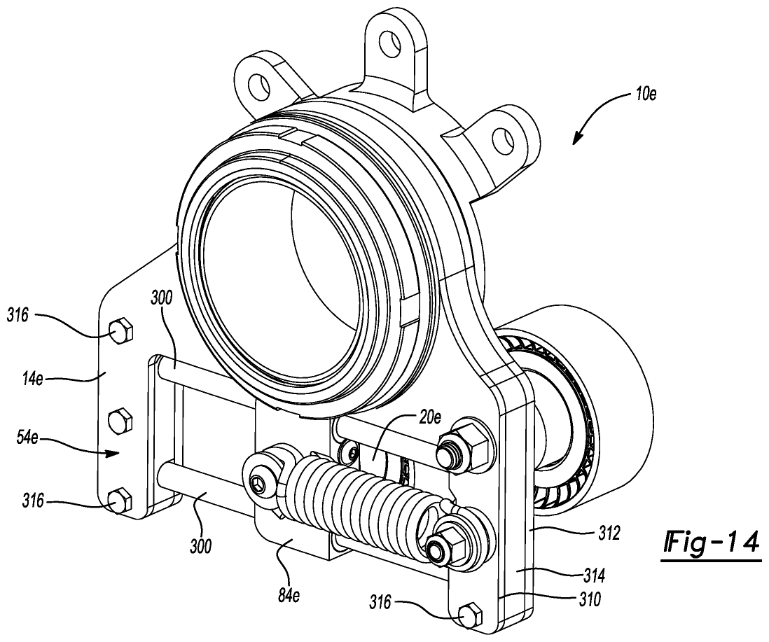

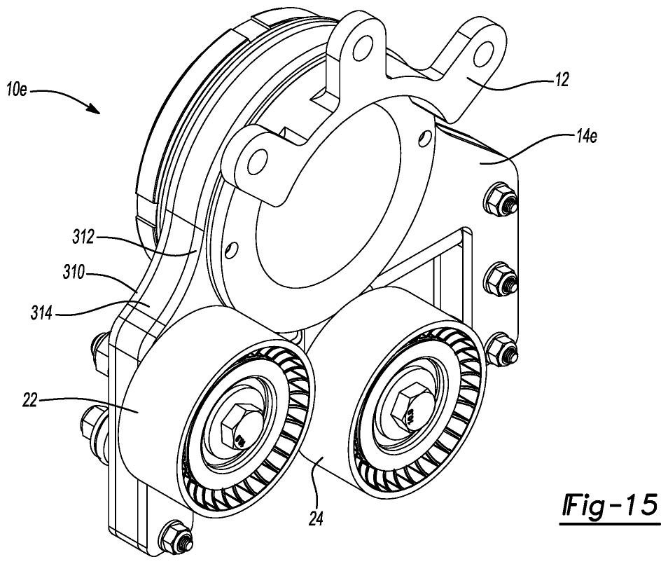

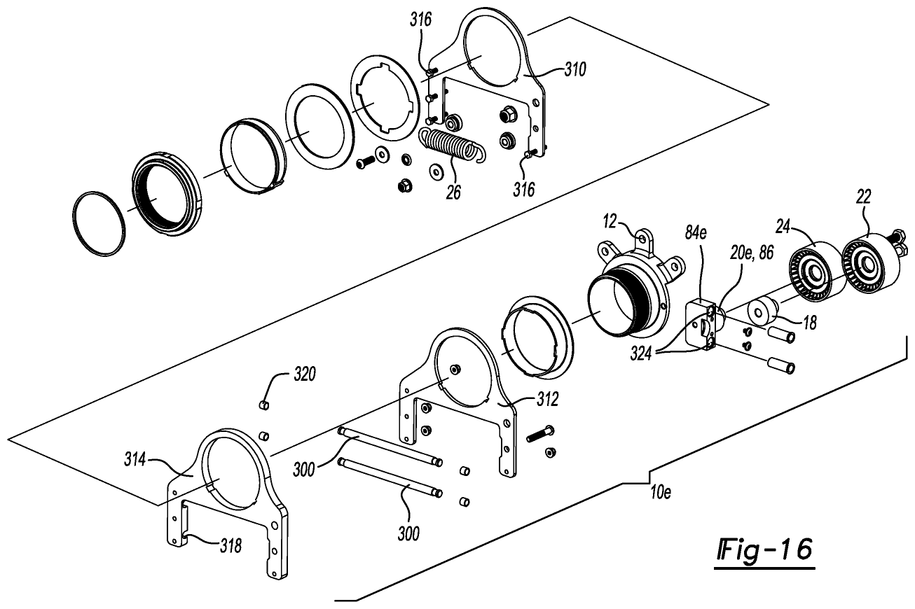

With reference to FIGS. 14 through 16, another tensioner constructed in accordance with the teachings of the present disclosure is generally indicated by reference numeral 10e. The tensioner 10e is generally similar to the tensioner 10 of FIG. 1, except for the configurations of the second mount 54e and the plate 84e. The second mount 54e can comprise one or more guide rails or rods 300 that can be fixedly mounted to the tensioner body 14e. In the example provided, the tensioner 10e employs a pair of cylindrically shaped rods 300 that are disposed parallel to one another and which are intended to provide movement of the second axle 20e along a straight path or line of action. It will be appreciated that the rod(s) 300 could be shaped with a non-circular transverse cross-section (e.g., square, rectangular) and/or that the rod(s) 300 could be shaped to provide movement along a path or line of action that is contoured in a desired manner (similar to the lines of action 60 through 60c shown in FIGS. 6 through 8). The rod(s) may be equipped with a seal or shield to protect the second axle 20e from contaminants. The seal or shield may cover a portion or all of the guide rails or rods 300 and may include bellows to allow the seal or shield to flex as the second axle 20e moves along the line of action 60.

If desired the tensioner body 14e could be formed in a composite or sandwich manner, having outer layers 310 and 312 formed of a suitable material, such as stamped steel, and an inner layer 314 that can be formed of a different material, such as plastic. The several layers 310, 312 and 314 can be fixedly coupled to one another via fasteners 316, such as rivets, screws of bolts. In the example provided, slots 318 are formed in the inner layer 314 and are configured to receive a bushing 320 that is in turn configured to receive an end of an associated one of the rods 300. It will be appreciated that the rod(s) 300 could be coupled/mounted to the tensioner body 14e in various different ways. For example, the inner layer 314 could be overmolded onto the rods 300 such that the inner layer 314 is cohesively bonded to the ends of the rods 300.

The plate 84e is configured to slidably receive the rod(s) 300 to permit the second axle 20e to be moved along the path or line of action defined by the rod(s) 300. The plate 84e could be formed in one or more pieces and defines rod apertures 324 that each receive an associated one of the rods 300. Like the embodiment of FIG. 1, the shaft structure 86 of the second axle 20e is fixedly coupled to the plate 84e.

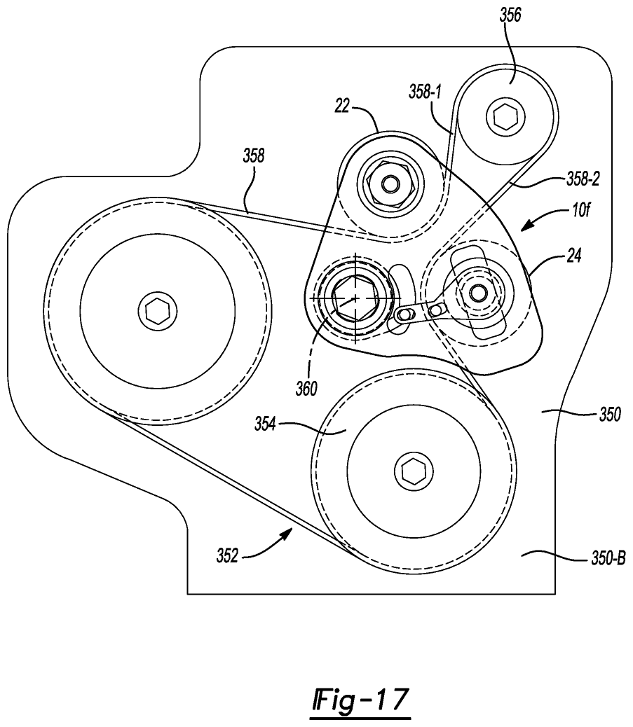

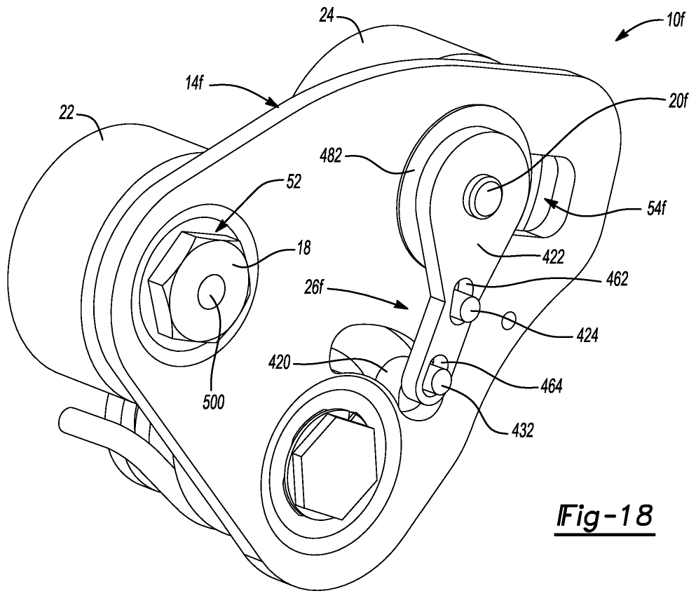

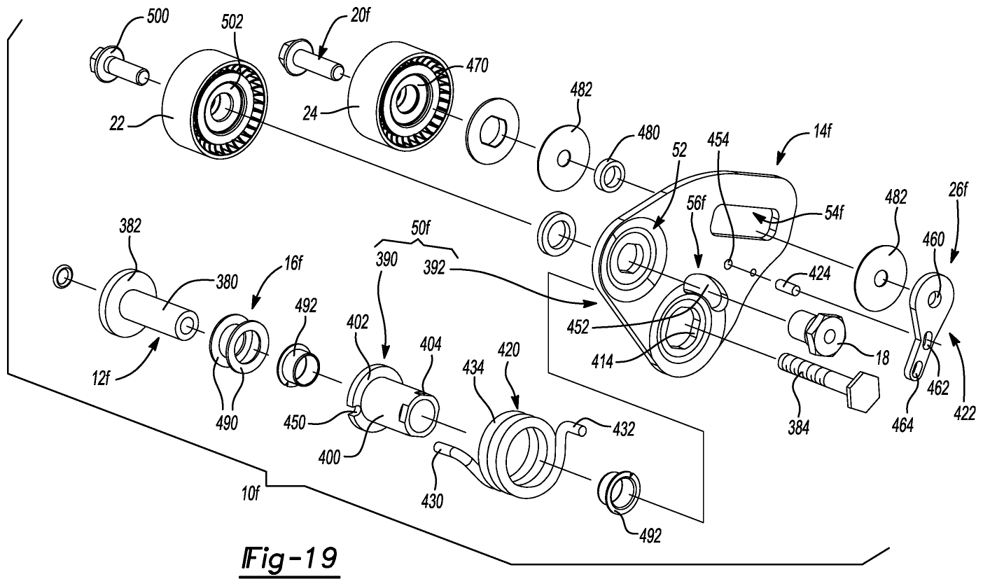

While the above-described examples have employed a tension spring to bias the second axle/second wheel toward the first axle/first wheel, it will be appreciated that the spring of the tensioner could be configured in various different ways. In the example of FIGS. 17 through 19, a fourth tensioner constructed in accordance with the teachings of the present disclosure is generally indicated by reference numeral 10f. The tensioner 10f is shown in operative association with an internal combustion engine 350 as part of a front engine accessory drive (FEAD) 352. The FEAD 352 includes a plurality of pulleys, including a crankshaft pulley 354 and a motor/generator pulley 356, and a belt 358 that is disposed about the several pulleys. The tensioner 10f is pivotably coupled to the cylinder block 350-B of the engine 350 for pivoting motion about a pivot axis 360 that is located at a location that is remote from the rotational axis of any of the pulleys (including the motor/generator pulley 356). It will be appreciated, however, that the tensioner 10f could be configured to be mounted to a motor/generator unit (not specifically shown) in a manner that is disclosed above, or that any of the above embodiments could be configured to be pivotally coupled to a suitable structure, such as the engine block of an internal combustion engine, for pivoting motion about an axis that is not coincident with the rotational axis of a motor/generator unit. The tensioner 10f is configured to pivot about the pivot axis 360 while the first and second wheels 22 and 24 contact spans 358-1 and 358-2 of the belt 358 that are disposed on opposite sides of the motor/generator pulley 356.

With reference to FIGS. 17-19, the tensioner 10f can include a bracket 12f, a tensioner body 14f, a friction control element 16f, a first axle 18, a second axle 20f, the first wheel 22, the second wheel 24 and a spring 26f. The bracket 12f has a hollow bracket hub 380 and a flange or head 382 that extends radially outwardly from the bracket hub 380. The hollow bracket hub 380 is configured to receive a threaded fastener 384 that extends through the bracket 12f and is threadably engaged to a threaded hole (not shown) in the structure to which the tensioner 10f is to be mounted (e.g., the cylinder block of an internal combustion engine). The threaded fastener 384 is configured to be tightened against an axial end of the hollow bracket hub 380 that is opposite the end on which the head 382 is formed to thereby non-rotatably couple the bracket 12f to the structure to which the tensioner 10f is mounted.

The tensioner body 14f can have a tensioner body hub 50f, a first mount 52, a second mount 54f, and a spring mount 56f. The tensioner body hub 50f can be formed in two distinct portions: a hub portion 390 and a body portion 392. The hub portion 390 includes a sleeve member 400, a flange 402, which extends radially outwardly from a first axial end of the sleeve member 400, and a first coupling portion 404 that is formed on a second axial end of the sleeve member 400. The hub portion 390 may allow for o-rings, seals, or shields to protect the area where the tensioner body 14f comes into moveable contact with the bracket 12f. In the example provided, the first coupling portion 404 comprises a plurality of flats that are formed on the second axial end of the sleeve member 400. The sleeve member 400 defines an aperture into which the hollow bracket hub 380 is received such that the flange 402 is proximate to (but spaced apart from) the head 382 of the of the bracket 12f.

The body portion 392 can be a plate-like structure that can define a second coupling portion 414 that is configured to be fixedly coupled to the first coupling portion 404. In the example provided, the second coupling portion 414 defines a non-circular aperture that is configured to receive the second end of the sleeve member 400 and non-rotatably engage the first coupling portion 404. If desired, an additional coupling means, such as a weld, staking or a press-fit, can be employed to further secure the first and second coupling portions 404 and 414 to one another.

The first and second mounts 52 and 54f can be fixedly coupled to the body portion 392 of the tensioner body hub 50f. The first mount 52 can comprise a stamped boss having a non-round aperture that is sized to receive the first axle 18, while the second mount 54f is configured as a slotted aperture that is disposed along a given path or line of action. The edges of the slotted aperture of the second mount 54f that extend along the path or line of action are guide rails that are employed to guide the second axle 20f along the path or line of action. The spring mount 56f can be tailored to the particular type of spring that is employed. In the example provided, the spring 26f includes a torsion spring 420, a lever 422 and a pivot pin 424. The torsion spring 420 has a first tang 430, a second tang 432 and a plurality of helical coils 434 that are disposed between the first and second tangs 430 and 432. The first tang 430 extends away from the helical coils 434 in a first direction generally parallel to an axis of the helical coils 434, while the second tang 432 extends away from the helical coils 434 in a second direction generally parallel to the axis of the helical coils 434.

In the example provided, the spring mount 56f includes a first tang aperture 450 formed in the flange 402 of the hub portion 390, a second tang aperture 452 formed in the body portion 392, and a pivot pin aperture 454 formed in the body portion 392. The torsion spring 420 is received on the hub portion 390 between the flange 402 and the body portion 392. The helical coils 434 are disposed about the sleeve member 400 and the first tang 430 is received in the first tang aperture 450, which is a slot that is formed into the flange 402. The second tang 432 is received through the second tang aperture 452. The lever 422 has an axle aperture 460, a pin slot 462 and a tang slot 464. The axle aperture 460 is disposed in-line with the slotted aperture that forms the second mount 54f. The pivot pin 424 is disposed through the pin slot 462, received in the pivot pin aperture 454 and fixedly coupled to the body portion 392. Optionally, the second tang 432 is received into the tang slot 464. The second axle 20f, which is a bolt in the example provided, is received through a bearing 470 mounted to the second wheel 24, the slotted aperture that forms the second mount 54f, and the axle aperture 460 in the lever 422. The second axle 20f can be coupled to the lever 422 in any desired manner, but is threadably engaged to threads defined by the axle aperture 460 in the example provided. If desired, a rotatable follower 480 can be received in the slotted aperture that forms the second mount 54f. The rotatable follower 480 can be received about the bolt that forms the second axle 20f and washers 482 can be disposed on the opposite sides of the body portion 392 to aid in retaining the follower 480 in the slotted aperture of the second mount 54f.

The friction control element 16f can comprise a plurality of Bellville spring washers 490 and a pair of bushings 492. The spring washers 490 can be disposed between the head 382 and the flange 402 and can bias the hub portion 390 along the threaded fastener 384 in a direction away from the head 382 of the bracket 12f. The bushings 492 can be received into the opposite axial ends of the sleeve member 400 of the hub portion 390.

The first axle 18 can be configured in a manner that is similar to that which is described above for the tensioner 10 and can be fixedly coupled to the first mount 52 in any desired manner. A threaded fastener 500 can be received through a bearing 502 in the first wheel 22 and can be threadably coupled to the first axle 18 to fixedly couple the first axle 18 and the bearing 502 to the body portion 392 of the tensioner body 14f.

It will be appreciated that the tensioner body 14f is rotatable about the bracket 12f and moreover that the second wheel 24 can be moved along the path or line of action between a first position, which can be spaced apart from the first wheel 22 by a first distance, and a second position that is spaced apart from the first wheel 22 by a second distance that is relatively smaller than the first distance. The spring 26f is employed to bias the second wheel 24 toward the second position. In this regard, the second tang 432 of the torsion spring 420 urges the lever 422 about the pivot pin 424 such that the lever 422 is moved in a rotational direction that urges the second wheel 24 toward the second position. When the tensioner 10f is installed as shown in FIG. 17, tension on the belt 358 will cause the second wheel 24 to move away from the first wheel 22. As tension in the belt 358 fluctuates, the second wheel 24 can be moved along the path or line of action by the belt 358 to rotate the lever 422 about the pivot pin 424 and store energy in or release stored energy from the torsion spring 420. It will be appreciated, too, that the tensioner body 14f will rotate about the bracket 12f when the “slack” and “tight” sides of the belt 358 (FIG. 17) change and that such rotation of the tensioner body 14f relative to the bracket 12f will be resisted or damped by the friction control element 16f.

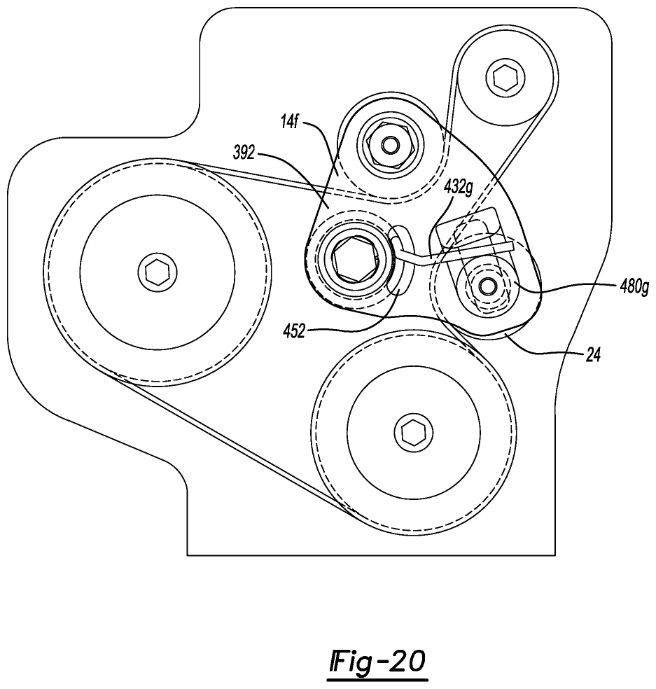

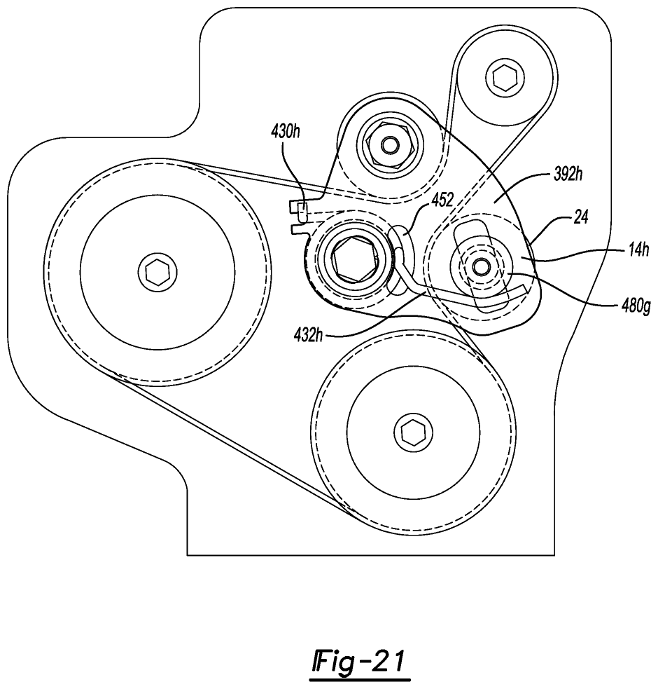

The examples of FIGS. 20 and 21 are generally similar to that of FIGS. 17-19, except for the construction of the spring that is employed to bias the second axle and second wheel relative to the tensioner body, first axle and first wheel. With reference to FIG. 20, the second tang 432g is received through the second tang aperture 452 in the body portion 392 of the tensioner body 14f and is engaged against the follower 480g to urge the second wheel 24 toward the first position. With reference to FIG. 21, the second tang 432h is received through the second tang aperture 452 in the body portion 392h of the tensioner body 14h and is engaged against the follower 480g to urge the second wheel 24 toward the second position. In this example, the first tang 430h is directly mounted to the body portion 392h of the tensioner body 14h, but it will be appreciated that the first tang 430h could be directly mounted to the hub portion 392h of the tensioner body 14h in a manner similar to that which is described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A tensioner (10, 10d, 10e, 10f) comprising:
a bracket (12, 120 having a bracket hub (32, 380);
a tensioner body (14, 14f, 14h) having a tensioner body hub (50, 50f), a first mount (52) and a second mount (54, 54d, 54e, 540, the tensioner body hub (50, 50f) being rotatably coupled to the bracket hub (32, 380), the first mount (52) and the second mount (54, 54d, 54e, 540 being fixedly coupled to the tensioner body hub (50, 50f);
a first axle (18) fixedly coupled to the first mount (52);
a second axle (20, 20e, 200 slidably coupled to the second mount (54, 54d, 54e, 540;
a first wheel (22) rotatably disposed on the first axle (18);
a second wheel (24) rotatably disposed on the second axle (20, 20e, 200; and
a spring (26, 260 coupled to the tensioner body (14, 14f, 14h) and biasing the second wheel (24) in a predetermined direction along a line of action.

2. The tensioner (10, 10d, 10e, 100 of claim 1, further comprising a friction control element (16, 160 received between the bracket (12, 120 and the tensioner body (14, 14f, 14h).

3. The tensioner (10, 10d, 10e, 100 of claim 2, wherein one of the bracket hub (32, 380) and the tensioner body hub (50, 500 defines an aperture into which the other one of the bracket hub (32, 380) and the tensioner body hub (50, 500 is received, and wherein the friction control element (16, 160 is disposed about the other one of the bracket hub (32, 380) and the tensioner body (14, 14f, 14h).

4. The tensioner (10, 10d, 10e) of claim 3, wherein the bracket hub (32) defines a first annular surface (68), the tensioner body hub (50, 500 defines a second annular surface (72), and the friction control element (16) is disposed axially between the first and second annular surfaces (66, 70).

5. The tensioner (10, 10d, 10e) of claim 1, wherein the second axle (20, 20e) includes a plate (84, 84d-1, 84d-2, 84e) that is slidably but non-rotatably coupled to the second mount (54, 54d, 54e).

6. The tensioner (10, 10d, 10e) of claim 5, wherein the second mount (54, 54d, 54e) defines one or more guide rails (96, 300) that guide the plate (84, 84d-1, 84d-2, 84e) as the second axle (20, 20e) is moved relative to the first axle (18) between first and second positions.

7. The tensioner (10, 10d, 10e) of claim 5, wherein a friction material is disposed between the plate (84, 84d-1, 84d-2, 84e) and the second mount (54, 54d, 54e).

8. The tensioner (10, 10d, 10e, 10f) of claim 1, wherein the second axle (20, 20e, 20f) is movable relative to the first axle (18) between a first position, in which the first axle (18) and the second axle (20, 20e, 20f) are spaced apart by a first distance, and a second position in which the first axle (18) and the second axle (20, 20e, 20f) are spaced apart by a second distance that is smaller than the first distance, and wherein an axis of the first axle (18) is disposed along the line of action.

9. The tensioner (10, 10d, 10e) of claim 1, wherein the spring (26) has a first hooked end that is disposed about one of the first axle (18) and the second axle (20, 20e).

10. The tensioner (10, 10d) of claim 9, wherein the spring (26) has a second hooked end that is disposed about the other one of the first axle (18) and the second axle (20).

11. The tensioner (100 of claim 1, wherein the spring (260 comprises a torsion spring (420).

12. The tensioner (100 of claim 11, wherein the torsion spring (420) has a plurality of helical coils (434), which are disposed about a portion of the bracket (120, and a tang (432) that extends through the tensioner body hub (50f).

13. The tensioner (100 of claim 12, wherein the tang (432) engages a lever (422) that is mounted to a pivot in the tensioner body hub (50f), and wherein the second axle (20f) is fixedly coupled to the lever (422).

14. The tensioner (100 of claim 12, wherein the tang (432g, 432h) engages a surface of a follower (480g) that is disposed concentrically about the second axle (200.

15. The tensioner (100 of claim 14, wherein the tang (432g) is disposed between the first axle (18) and the second axle (20f).

16. The tensioner (10, 10d, 10e, 10f) of claim 1, wherein the second wheel (24) is biased toward the first wheel (22).

17. A tensioner (10, 10d, 10e, 10f) comprising:
a bracket (12, 12f);
a tensioner body (14, 14f, 14h) coupled to the bracket (12, 12f) for rotation about a first axis;
a first wheel (22) coupled to the tensioner body (14, 14f, 14h) for rotation about a second axis that is parallel the first axis;
a second wheel (24) that is rotatable about a third axis that is parallel the first axis, the second wheel (24) being coupled to the tensioner body (14, 14f, 14h) for movement between a first position and a second position in which the third axis is spaced apart from the second axis; and
a spring (26, 260 configured to bias the second wheel (24) in a predetermined direction along a line of action.

18. (canceled)

19. The tensioner (10, 10d, 10e, 10f) of claim 17, wherein the second wheel (24) is mounted to an axle (20, 20d, 20e, 20f) and wherein the tensioner body (14, 14f, 14h) includes a guide rail (96, 300) that constrains movement of the axle along the line of action.

20. (canceled)

21. (canceled)

22. (canceled)

23. (canceled)

24. (canceled)

25. The tensioner (100 of claim 17, wherein the spring (260 comprises a torsion spring (420).

26. (canceled)

27. (canceled)

28. (canceled)

29. (canceled)

30. (canceled)

31. The tensioner (10, 10d, 10e, 10f) of claim 17, wherein the second axis lies along the line of action.
